(19) United States
(12) Patent Application Publication
(10) Pub. No.: US 2026/0213997 A1
(43) Pub. Date: Jul. 23, 2026

(54) METHOD AND APPARATUS FOR MANAGING NETWORK SLICES IN A WIRELESS COMMUNICATION SYSTEM

(71) Applicant: SAMSUNG ELECTRONICS CO., LTD., Suwon-si, Gyeonggi-do (KR)

(72) Inventors: Ashutosh KAUSHIK, Bangalore, Karnataka (IN); Deepanshu GAUTAM, Bangalore, Karnataka (IN); Ashok Kumar NAYAK, Bangalore, Karnataka (IN)

(21) Appl. No.: 19/143,268

(22) PCT Filed: Dec. 21, 2023
(86) PCT No.: PCT/KR2023/021312

§ 371 Date: Jun. 25, 2025

(30) Foreign Application Priority Data
Dec. 25, 2022 (IN) 202241075242
Dec. 13, 2023 (IN) 202241075242

(51) Int. Cl. H04L 41/0816

(52) U.S. Cl. CPC H04L 41/0816

(57) ABSTRACT

The disclosure relates to a 5G or 6G communication system for managing network slices in a wireless communication system. According to an embodiment, the method comprises configuring a sliceValidityTime attribute in at least one associated node for a network slice using the allocateNSI and createMOI operations. The method further comprises deleting the network slice for a first configured time stamp when the network slice is not required and suspending the network slice for a second configured time period when the network slice is not in use. The method further comprises modifying the configuration related to the network slice in the associated nodes based on the received request. Embodiments herein can be used to avoid the unnecessary flow of management data in the network, and to provide efficient utilization of virtualized network resources in a data center.

### TECHNICAL FIELD

The present disclosure relates to wireless communication system, and more particularly to method and apparatus for network slice management in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal object of the embodiments herein is to disclose method and apparatus for managing network slices in a wireless communication system.

One object of the embodiment herein is to disclose method and apparatus for configuring a sliceValidityTime attribute in at least one associated node for a network slice using an allocateNSI (Network Slice Instance) and createMOI (Managed Object Instance) operation.

One object of the embodiment herein is to disclose methods and apparatus for enabling implicit deletion of a short-lived or volatile network slice instance when the network slice is not required.

One object of the embodiment herein is to disclose methods and apparatus for providing an implicit suspension of the short-lived or volatile network slice instance when the network slice is not in use for a given duration.

One object of the embodiment herein is to disclose methods and apparatus for modifying the configuration related to the network slice in the associated nodes based on the received request.

### Solution to Problem

The embodiments herein achieve methods and systems for network slice management in the wireless network. In an embodiment shown herein, the proposed method includes a solution for optimized network slice management by providing mechanisms to implicitly suspend the slice, i.e., make the slice temporarily unavailable when the slice is not being used, and implicitly delete the slice when the slice is not required anymore.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 is an example sequence diagram illustrating the process of provisioning a slice using an allocateNSI (Network Slice Instance) operation of a network slice provisioning management service defined in 3GPP TS 28.531, according to one embodiment of the present disclosure;

FIG. 2 is an example sequence diagram illustrating the process of provisioning a slice using a createMOI (Managed Object Instance) operation, targeting NetworkSlice IOC (Information Object Class), of a generic provisioning management service defined in 3GPP TS 28.532, according to one embodiment of the present disclosure;

FIG. 3 is a block diagram of a Provisioning MnS (Management Service) Producer, according to one embodiment of the present disclosure;

FIG. 4 is a flowchart illustrating a method, implemented by the Provisioning MnS Producer, for managing network slices in a wireless communication system using the allocateNSI operation, according to one embodiment of the present disclosure; and

FIG. 5 is a flowchart illustrating a method, implemented by the Provisioning MnS Producer, for managing network slices in a wireless communication system using the createMOI operation, according to one embodiment of the present disclosure.

### BEST MODE FOR CARRYING OUT THE INVENTION

According to one embodiment herein, a method for managing network slices in a wireless communication system is provided. The method comprises receiving, by a Provisioning Management Service (MnS) Producer, an allocateNSI (Network Slice Instance) request from a Provisioning MnS Consumer. The allocateNSI request comprises at least one attribute. The attribute sliceValidityTime is a sliceValidityInfo datatype. The sliceValidityTime attribute comprises an expiryTime attribute and a suspensionWindow attribute. The method further comprises configuring, by the Provisioning MnS Producer, the sliceValidityTime attribute in at least one associated node for the network slice. The method further comprises sending, by the Provisioning MnS Producer, an allocateNSI response to the Provisioning MnS Consumer for the configured network slice.

According to one embodiment hrein, a method for managing network slices in a wireless communication system is provided. The method comprises receiving, by a Provisioning Management Service (MnS) Producer, a createMOI (Managed Object Instance) request from a Provisioning MnS Consumer. The createMOI request comprises at least one attribute. The attribute sliceValidityTime is a sliceValidityInfo datatype. The sliceValidityTime attribute comprises an expiryTime attribute and a suspensionWindow attribute. The method further comprises configuring, by the Provisioning MnS Producer, the sliceValidityTime attribute in at least one associated node for the network slice. The method further comprises sending, by the Provisioning MnS Producer, a createMOI response to the Provisioning MnS Consumer for the configured network slice.

According to one embodiment herein, a Provisioning Management Service (MnS) Producer for managing network slices in a wireless communication system is provided. The Provisioning MnS Producer includes a network slice managing controller coupled with a processor and memory. The network slice managing controller is configured to receive an allocateNSI (Network Slice Instance) request from a Provisioning MnS Consumer. The allocateNSI request comprises at least one attribute. The attribute sliceValidityTime is a sliceValiditylnfo datatype. The sliceValidityTime attribute comprises an expiryTime attribute and a suspensionWindow attribute. The network slice managing controller is further configured to configure the sliceValidityTime attribute in at least one associated node for the network slice. The network slice managing controller is further configured to send an allocateNSI response to the Provisioning MnS Consumer for the configured network slice.

According to one embodient herein, a Provisioning Management Service (MnS) Producer for managing network slices in a wireless communication system is provided. The Provisioning MnS Producer includes a network slice managing controller coupled with a processor and memory. The network slice managing controller is configured to receive a createMOI (Managed Object Instance) request from a Provisioning MnS Consumer. The createMOI request comprises at least one attribute, sliceValidityTime. The attribute sliceValidityTime is a sliceValidityInfo datatype. The sliceValidityTime attribute comprises an expiryTime attribute and a suspensionWindow attribute. The network slice managing controller is further configured to configure the sliceValidityTime attribute in at least one associated node for the network slice. The network slice managing controller is further configured to send a createMOI response to the Provisioning MnS Consumer for the configured network slice.

These and other aspects of the embodiments herein will be better appreciated and understood when considered in conjunction with the following description and the accompanying drawings. It should be understood, however, that the following de-scriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Currently, a Fifth Generation (5G) system comprises of a 5G Access Network (AN), a 5G Core Network, and User Equipment (UE), as specified in TS 23.501. The 5G system is expected to be able to provide optimized support for a variety of different communication services, different traffic loads, and different end user communities. In an example, the communication services using network slicing may include Vehicle-to-Everything (V2X) services. The 5G system aims to enhance its capability to meet the Key Performance Indicators (KPIs) that emerging V2X applications require. For these advanced applications, the requirements (such as data rate, reliability, latency, communication range, and speed) are made more stringent with 5G seamless Enhanced Mobile Broadband (eMBB). As one of the key technologies to enable network slicing, Fixed Mobile Convergence (FMC), which includes Wireless-to-Everything (WTTx) and Fibre-to-Everything (FTTx), is expected to provide native support for network slicing.

For optimization and resource efficiency, the 5G system will select the most appropriate 3rd Generation Partnership Project (3GPP) or non-3GPP access technology for a communication service, potentially allowing multiple access technologies to be used simultaneously for one or more services active on the UE and massive IoT connections. Support for the massive Internet of Things (mIoT) brings many new requirements in addition to MBB enhancements. Communication services with massive IoT connections, such as smart households, smart grids, smart agriculture, and smart meters, will require the support of a large number of high density IoT devices to be efficient and cost effective. Operators can use one or more network slice instances to provide these communication services, which require similar network characteristics, to different vertical industries. 3GPP TS 28.530 and 28.531 define the management of network slices in 5G networks. It also defined the concept of communication services, which are provided using one or multiple network slices. A Network Slice Instance (NSI) may support multiple Communication Service Instances (CSI). Similarly, a CSI may utilize multiple NSIs.

Global System for Mobile Communications Association (GSMA) has introduced Generic Slice Template (GST) to provide a standardized list of attributes that can characterize a type of network slice. Network slicing is the key feature of 5G networks and enables the building of dedicated logical networks on a shared infrastructure. These dedicated networks would permit the implementation of tailor-made functionality and network operation specific to the needs of each slice of customer rather than a one-size-fits-all approach as witnessed in the current and previous mobile generations, which would not be economically viable.

Slicing enables provisioning network resources at runtime for a specific purpose. Some slices can be short-lived, i.e., an exclusive slice can be provisioned for providing eMBB service to the broadcast service provider to cover a football match in a particular stadium at a particular time. Some slices can be long-lived in nature, i.e., a slice providing eMBB service to a hospital.

In the existing standards or methods, there is no mechanism for implicit suspension or deletion of a short-lived or volatile network slice instance, i.e., a slice created especially for some event or occasion and is required for a short duration. The slice may also remain unused for a certain period during its existence. As per the current mechanism, when a slice is deleted (i.e., the Managed Object instance (MOI) of the slice is deleted), notifications are sent from the management system to all the subscribed recipients, including 5GC and RAN NFs. Once the notification is received, the slice information is removed by the related Network Function (NF) from the rest of the network, including 5GC, RAN, and UE. When these notifications are sent for every volatile slice, it creates an unnecessary flow of management data in the network. The other drawback of the existing mechanism is that to receive such notifications, NF has to become a provisioning Management Service (MnS) consumer i.e., it then needs to know the Network Resource Model (NRM) details maintained by the management domain of the network, which may not always be suitable for every NF.

Hence, there is a need in the art for solutions that will overcome the above mentioned drawback(s), among others.

The embodiments herein achieve methods and systems for network slice management in the wireless network. In an embodiment shown herein, the proposed method includes a solution for optimized network slice management by providing mechanisms to implicitly suspend the slice, i.e., make the slice temporarily unavailable when the slice is not being used, and implicitly delete the slice when the slice is not required anymore.

Embodiments herein can be used to enable implicit deletion of a short-lived or volatile network slice instance when it is not required anymore. Embodiments herein can be used to provide an implicit suspension of a short-lived or volatile network slice instance when it is not in use for a given duration. Embodiments herein can be used to avoid the unnecessary flow of management data in the network in the form of notifications, for example. Embodiments herein can be used to provide efficient utilization of virtualized network resources in a data center. Embodiments herein can be used to prevent the network function from being aware of network NRM, which otherwise becomes mandatory when the NF acts like a Provisioning MnS Consumer for subscribing to notifications.

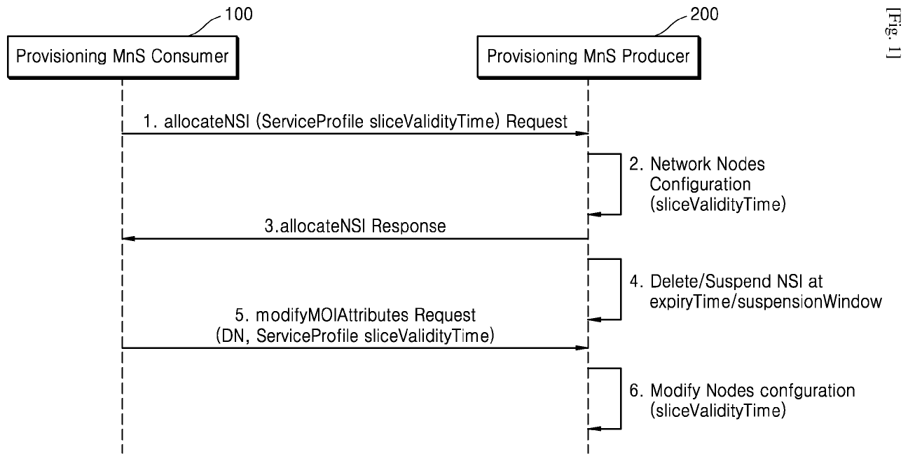

Referring now to the drawings, and more particularly to FIGS. 1 through 5, where similar reference characters denote corresponding features consistently throughout the figures, there is at least one embodiment.

Embodiments herein include the solution for performing optimized network slice management by providing mechanisms to implicitly suspend the slice, i.e., make the slice temporarily unavailable (when the slice is not being used), and implicitly delete the slice (when the slice is not required).

Embodiments herein disclose an attribute sliceValidityTime, which is defined as an attribute of a ServiceProfile, for providing network slice requirements to a management system. When a consumer wants a slice, the consumer sends the ServiceProfile to the management system, wherein the ServiceProfile contains requirements for the network slice.

The sliceValidityTime provides information about the expiry time and suspension period of a network slice instance. This enables the corresponding configuration in network functions for implicit suspension and/or deletion of the network slice instance.

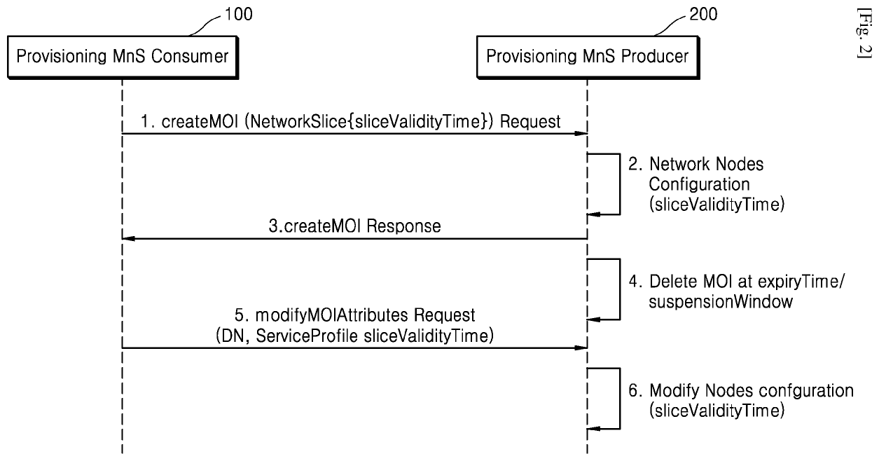

In an embodiment herein, the configuration of sliceValidityTime can be done by two different mechanisms:
1) By using the allocateNSI (Network Slice Instance) operation of the network slice provisioning management service defined in 3GPP TS 28.531 (as shown in FIG. 1):
2) By using the createMOI (Managed Object Instance) operation, targeting the NetworkSlice IOC (Information Object Class) of the generic provisioning management service defined in 3GPP TS 28.532 (as shown in FIG. 2):

The attribute sliceValidityTime is of the datatype sliceValidityInfo. The attribute sliceValidityTime contains the following attributes:
1. expiryTime: This attribute provides information about the time at which the slice instance is configured to expire, i.e., the time at which the network slice instance related configuration should be deleted from the network.
2. suspensionWindow: This attribute provides information about the scheduled period during which the slice is not going to be used while it exists. It contains the attributes startSuspensionTime and endSuspensionTime as defined below:
a) startSuspensionTime: It defines the time stamp to start slice suspension, i.e., the time at which the Network Functions Virtualization Management and Orchestration (NFV MANO) can be requested to release the associated virtual resources, i.e., scale-in.
b) endSuspensionTime: It defines the time stamp to end slice suspension, i.e., the time at which the NFV MANO can be requested to allocate the associated virtual resources, i.e., scale-out.

FIG. 1 is an example sequence diagram illustrating the process of provisioning a slice using the allocateNSI operation of the network slice provisioning management service defined in 3GPP TS 28.531.

The management system comprises a Provisioning Management Service (Mns) Consumer and a Provisioning Mns Producer. The Provisioning MnS Consumer can be an entity in an operation domain. The Provisioning MnS Producer can be any functional module running in a management plane that manages slices. The Provisioning MnS Producer can be any entity, such as, but not limited to, a network slice management service producer, network slice manager, orchestrator, and so on.
At step 1, the Provisioning MnS Consumer sends the allocateNSI request to the Provisioning MnS Producer. The the allocateNSI request contains the attribute sliceValidityTime as a ServiceProfile attribute.
At step 2, the Provisioning MnS producer configures the sliceValidityTime attribute in one or more associated nodes, which comprises performing the network slice related configuration.
At step 3, the Provisioning MnS Producer sends the allocateNSI response to the Provisioning MnS Consumer.
At step 4, to facilitate the expiry, the network slice is deleted from all associated network nodes at expiryTime. To facilitate the suspension, the network slice is suspended during suspensionWindow, i.e., administrativeState of the NetworkSlice IOC will be updated to locked. This will be an indication for a Network Function Management Function (NFMF) to ask the NFV MANO to release the resources.
At step 5, if the pre-configured sliceValidityTime information of the slice needs to be updated (for example, due to the uncertainty of a live event), the slice can be updated by sending a modifyMOIAttributes request from the Provisioning MnS Consumer to the Provisioning MnS Producer.
At step 6, slice related configurations are modified by the Provisioning MnS Producer in all associated nodes.

FIG. 2 is an example sequence diagram illustrating the process of provisioning a slice using the createMOI operation, targeting the NetworkSlice IOC, of the generic provisioning management service defined in 3GPP TS 28.532.
At step 1, the Provisioning MnS Consumer sends the createMOI request to the Provisioning MnS Producer. The createMOI request contains the attribute sliceValidityTime as a ServiceProfile attribute.
At step 2, the Provisioning MnS producer configures the sliceValidityTime attribute in one or more associated nodes, where network slice related configuration needs to be done.
At step 3, the Provisioning MnS Producer sends the createMOI response to the Provisioning MnS Consumer.
At step 4, to facilitate the expiry, the network slice is deleted from all associated network nodes at expiryTime. To facilitate the suspension, the network slice is suspended during suspensionWindow i.e. the administrative state of the network slice IOC will be updated to locked. This will be an indication for the NFMF to ask NFV MANO to release the resources.
At step 5, if the pre-configured sliceValidityTime information of the slice needs to be updated due to the uncertainty of a live event, the slice can be updated by sending the modifyMOIAttributes request from the Provisioning MnS Consumer to the Provisioning MnS Producer.
At step 6, slice related configurations are modified by the Provisioning MnS Producer in all associated nodes.

Tables 1-3 shows an example Network Resource Model.

sliceValidityInfo, <<dataType>>

The <<dataType>> defines the network slice expiry and suspension time related information for a particular slice instance.

### Attributes:

TABLE 1

| Attribute name | S | isReadable | isWritable | isInvariant | isNotifyable |
|---|---|---|---|---|---|
| expiryTime | M | T | T | F | T |
| suspensionWindow | M | T | T | F | T |

Duration <<dataType>>

This <<dataType>> defines the network slice suspension related information.

### Attributes:

TABLE 2

| Attribute name | S | isReadable | isWritable | isInvariant | isNotifyable |
|---|---|---|---|---|---|
| startSuspensionTime | M | T | T | F | T |
| endSuspensionTime | M | T | T | F | T |

Table 3 defines the properties of attributes specified in the proposed method.

TABLE 3

| Attribute Name | Documentation and Allowed Values | Properties |
|---|---|---|
| sliceValidityTime | This defines the network slice time | type: sliceValidityInfo |
| | validity related information, like its | multiplicity: 1 |
| | expiry time or suspension time. | isOrdered: N/A |
| | | isUnique: N/A |
| | | defaultValue: None |
| | | isNullable: False |
| expiryTime | Provides information about the time at | type: DateTime |
| | which the slice instance is scheduled to | multiplicity: 1 |
| | expire as it is not required anymore, | isOrdered: N/A |
| | i.e., the time at which the network slice | isUnique: N/A |
| | instance related configuration will be | defaultValue: None |
| | deleted from the network. | isNullable: False |
| suspensionWindow | Provides information about the | type: Duration |
| | scheduled period during which the slice | multiplicity: * |
| | is not going to be used while it exists. It | isOrdered: N/A |
| | contains the attributes startSuspensionTime | isUnique: False |
| | and endSuspensionTime. | defaultValue: None |
| | | isNullable: False |
| startSuspensionTime | Defines time stamp to start slice | type: DateTime |
| | suspension, i.e., the time at which the | multiplicity: 1 |
| | NFV MANO can be requested to release the | isOrdered: N/A |
| | associated virtual resources, i.e., scale-in | isUnique: N/A |
| | | defaultValue: None |
| | | isNullable: False |
| endSuspensionTime | Defines the time stamp to end slice | type: DateTime |
| | suspension, i.e., the time at which the | multiplicity: 1 |
| | NFV MANO can be requested to allocate the | isOrdered: N/A |
| | associated virtual resources, i.e., scale-out. | isUnique: N/A |
| | | defaultValue: None |
| | | isNullable: False |

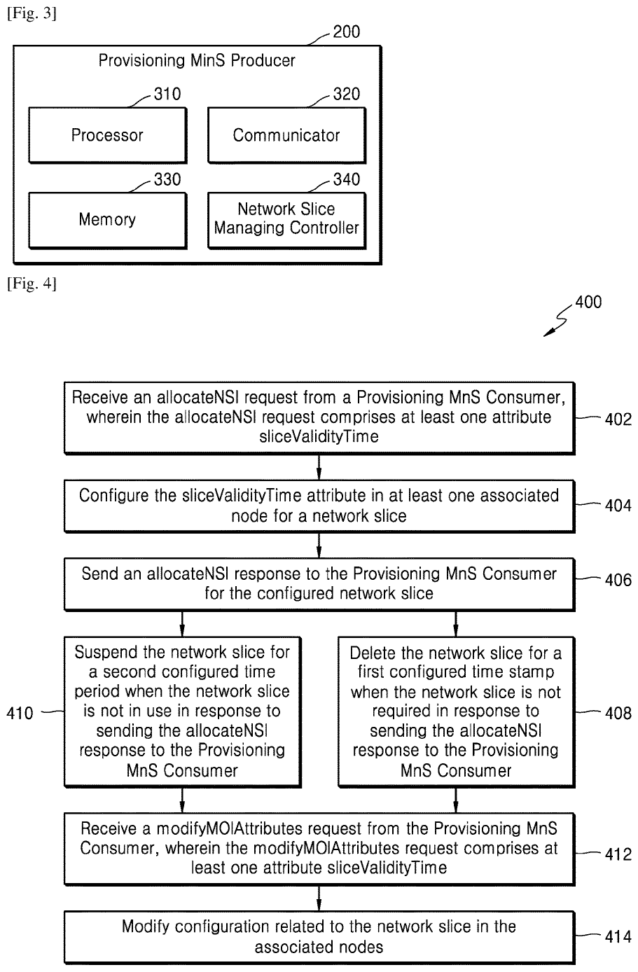

FIG. 3 is block diagram of the Provisioning MnS Producer 200, according to one embodiment of the present disclosure.

In an embodiment, the Provisioning MnS Producer 200 includes a processor 310, a communicator 320, a memory 330, and a network slice managing controller 340. The processor 310 is coupled with the communicator 320, the memory 330, and the network slice managing controller 340.

The network slice managing controller 340 can receive an allocateNSI request from a Provisioning MnS Consumer 100. The allocateNSI request comprises at least one attribute, sliceValidityTime, as part of the ServiceProfile attribute. The ServiceProfile attribute contains requirements for the network slice. Based on the request, the network slice managing controller 340 can configure the sliceValidityTime attribute in at least one associated node for the network slice. Based on the configured network slice, the network slice managing controller 340 can send an allocateNSI response to the Provisioning MnS Consumer 100.

Further, the network slice managing controller 340 can perform at least one of deleting the network slice in response to sending the allocateNSI response to the Provisioning MnS Consumer 100 for a first configured time stamp (when the network slice is not required), wherein the first configured time stamp refers to the expiryTime attribute as included in the allocateNSI request, and suspending the network slice in response to sending the allocateNSI response to the Provisioning MnS Consumer 100 for a second configured time period (when the network slice is not in use), wherein the second configured time period refers to the suspensionWindow attribute as included in the allocateNSI request.

The first configured time stamp mentions the expiry time for the network slice. The network slice is not available after the expiration time. When the time expires, the network slice managing controller 340 can delete the network slice.

The second configured time period provides information about the suspensionWindow attribute for the network slice. The second configured time period mentions the startSuspensionTime attribute and endSuspensionTime attribute. The second configured time period gives an array of suspension times. For example, the suspension time starts from 1 pm to 2 pm and then from 5 pm to 6 pm. The network slice is not available for the mentioned time period (from 1 pm to 2 pm and then from 5 pm to 6 pm). The network slice managing controller 340 can suspend the network slice for the second configured time period. The rest of the time, the network slice is available.

Further, the network slice managing controller 340 can receive a modifyMOI (Managed Object Instance) Attributes request from the Provisioning MnS Consumer 100. The modifyMOIAttributes request comprises at least one attribute, sliceValidityTime, as part of the ServiceProfile attribute. The ServiceProfile attribute contains requirements for the network slice. Based on the received modifyMOIAttributes request, the network slice managing controller 340 can modify the configuration related to the network slice in the associated nodes.

The network slice managing controller 340 can receive a createMOI request from a Provisioning MnS Consumer 100. The createMOI request comprises at least one attribute, sliceValidityTime, as part of the ServiceProfile attribute. The ServiceProfile attribute contains requirements for the network slice. Based on the request, the network slice managing controller 340 can configure the sliceValidityTime attribute in at least one associated node for the network slice. Based on the configured network slice, the network slice managing controller 340 can send a createMOI response to the Provisioning MnS Consumer 100.

Further, the network slice managing controller 340 can perform at least one of deleting the network slice in response to sending the createMOI response to the Provisioning MnS Consumer 100 for a first configured time stamp, when the network slice is not required, wherein the first configured time stamp refers to the expiryTime attribute as included in the createMOI request, and suspending the network slice in response to sending the createMOI response to the Provisioning MnS Consumer 100 for a second configured time period, when the network slice is not in use, wherein the second configured time period refers to the suspensionWindow attribute as included in the createMOI request.

The first configured time stamp mentions the expiry time for the network slice. The network slice is not available after the expiration time. When the time expires, the network slice managing controller 340 can delete the network slice.

The second configured time period provides information about the suspensionWindow attribute for the network slice. The second configured time period mentions the startSuspensionTime attribute and endSuspensionTime attribute. The second configured time period gives an array of suspension times. For example, the suspension time starts from 1 pm to 2 pm and then from 5 pm to 6 pm. The network slice is not available for the mentioned time period (from 1 pm to 2 pm and then from 5 pm to 6 pm). The network slice managing controller 340 can suspend the network slice for the second configured time period. The rest of the time, the network slice is available.

Further, the network slice managing controller 340 can receive a modifyMOIAttributes request from the Provisioning MnS Consumer 100. The modifyMOIAttributes request comprises at least one attribute, sliceValidityTime, as part of the ServiceProfile attribute. The ServiceProfile attribute contains requirements for the network slice. Based on the received modifyMOIAttributes request, the network slice managing controller 340 can modify the configuration related to the network slice in the associated nodes.

The network slice managing controller 340 is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor 310 is configured to execute instructions stored in the memory 330 and to perform various processes. The communicator 320 is configured for communicating internally between internal hardware components and with external devices via one or more networks. The memory 330 also stores instructions to be executed by the processor 310.

The memory 330 may include non-volatile storage elements. Examples of such non-volatile storage elements may include magnetic hard discs, optical discs, floppy discs, flash memories, or forms of Electrically Programmable Memories (EPROM) or Electrically Erasable and Programmable (EEPROM) Memories.

In addition, the memory 330 may, in some examples, be considered a non-transitory storage medium. The term “non-transitory” may indicate that the storage medium is not embodied in a carrier wave or a propagated signal. However, the term “non-transitory” should not be interpreted that the memory 330 is non-movable. In certain examples, a non-transitory storage medium may store data that can, over time, change (e.g., in Random Access Memory (RAM) or cache).

The processor 310 may include one or a plurality of processors. At this time, one or a plurality of processors may be a general purpose processor, such as a Central Processing Unit (CPU), an Application Processor (AP), or the like, a graphics-only processing unit, such as a Graphics Processing Unit (GPU), a Visual Processing Unit (VPU), and/or an AI-dedicated processor, such as a Neural Processing Unit (NPU).

Although FIG. 3 shows various hardware components of the Provisioning MnS Producer 200, it is to be understood that other embodiments are not limited thereto. In other embodiments, the Provisioning MnS Producer 200 may include less or more components. Further, the labels or names of the components are used only for illustrative purposes and do not limit the scope of the invention. One or more components can be combined to perform the same or substantially similar function in the Provisioning MnS Producer 200.

FIG. 4 is a flowchart illustrating a method 400 for managing network slices in a wireless communication system using the allocateNSI operation, according to one embodiment of the present disclosure. The operations (402-414) are handled by the network slice manager 340.

At step 402, the method discloses receiving, by the Provisioning MnS Producer 200, the allocateNST request from the Provisioning MnS Consumer 100. The allocateNST request comprises at least one attribute, sliceValidityTime, as part of the ServiceProfile. The ServiceProfile contains requirements for the network slice. The sliceValidityTime provides information about the expiration time and suspension period of the network slice instance.

At step 404, the method discloses configuring, by the Provisioning MnS Producer 200, the sliceValidityTime attribute in at least one associated node for the network slice.

At step 406, the method discloses sending, by the Provisioning MnS Producer 200, the allocateNSI response to the Provisioning MnS Consumer 100 for the configured network slice.

At step 408, the method discloses performing, by the Provisioning MnS Producer 200, at least one of deleting the network slice for a first configured time stamp (when the network slice is not required), in response to sending the allocateNSI response to the Provisioning MnS Consumer 100. The first configured time stamp refers to the expiryTime attribute as included in the allocateNSI request.

At step 410, the method discloses suspending the network slice for a second configured time period (when the network slice is not in use), in response to sending the allocateNSI response to the Provisioning MnS Consumer 100. The second configured time period refers to the suspensionWindow attribute as included in the allocateNSI request.

At step 412, the method discloses receiving, by the Provisioning MnS Producer 200, a modifyMOIAttributes request from the Provisioning MnS Consumer 100. The modifyMOIAttributes request comprises at least one attribute, and sliceValidityTime. The sliceValidityTime provides information about the expiration time and suspension period of the network slice instance.

At step 414, the method discloses modifying, by the Provisioning MnS Producer 200, the configuration related to the network slice in the associated nodes based on the received modifyMOIAttributes request.

The various actions in method 400 may be performed in the order presented, in a different order or simultaneously. Further, in some embodiments, some actions listed in FIG. 4 may be omitted.

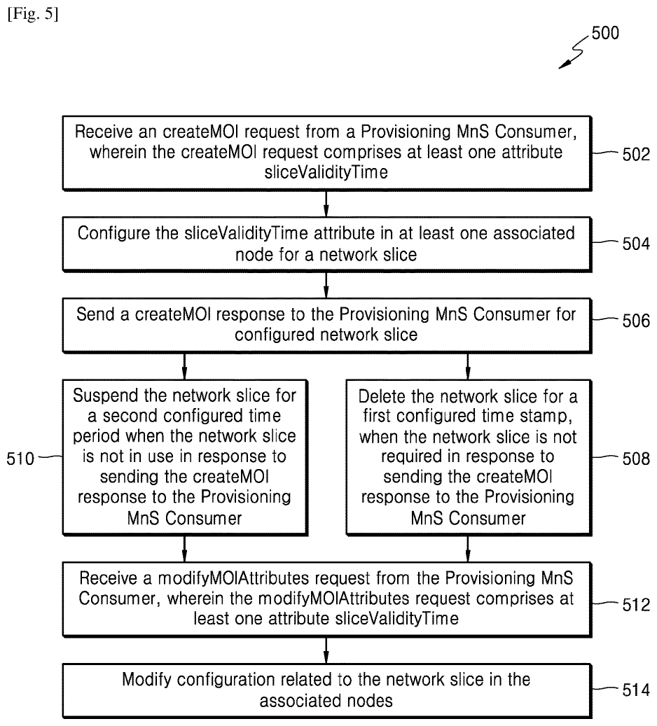

FIG. 5 is a flowchart illustrating a method 500 for managing network slices in a wireless communication system using the createMOI operation, according to one embodiment of the present disclosure. The operations (502-514) are handled by the network slice manager 340.

At step 502, the method discloses receiving, by the Provisioning MnS Producer 200, the createMOI request from the Provisioning MnS Consumer 100. The createMOI request comprises at least one attribute, sliceValidityTime, in the NetworkSlice IOC, which is an instant object class. The sliceValidityTime provides information about the expiration time and suspension period of the network slice instance.

At step 504, the method discloses configuring, by the Provisioning MnS Producer 200, the sliceValidityTime attribute in at least one associated node for the network slice.

At step 506, the method discloses sending, by the Provisioning MnS Producer 200, the createMOI response to the Provisioning MnS Consumer 100 for the configured network slice.

At step 508, the method discloses performing, by the Provisioning MnS Producer 200, at least one of deleting the network slice for a first configured time stamp when the network slice is not required in response to sending the createMOI response to the Provisioning MnS Consumer 100. The first configured time stamp refers to the expiryTime attribute as included in the createMOI request.

At step 510, the method discloses suspending the network slice for a second configured time period when the network slice is not in use in response to sending the createMOI response to the Provisioning MnS Consumer 100. The second configured time period refers to the suspensionWindow attribute as included in the createMOI request.

At step 512, the method discloses receiving, by the Provisioning MnS Producer 200, a modifyMOIAttributes request from the Provisioning MnS Consumer 100. The modifyMOIAttributes request comprises at least one attribute, sliceValidityTime. The sliceValidityTime provides the expiration time and suspension period of the network slice instance.

At step 514, the method discloses modifying, by the Provisioning MnS Producer 200, the configuration related to the network slice in the associated nodes based on the received modifyMOIAttributes request.

The various actions in method 500 may be performed in the order presented, in a different order or simultaneously. Further, in some embodiments, some actions listed in FIG. 5 may be omitted.

The embodiments disclosed herein can be implemented through at least one software program running on at least one hardware device and performing network management functions to control the network elements. The network elements shown in FIG. 3 include blocks, which can be at least one hardware device or a combination of hardware devices and software modules.

The embodiment disclosed herein describes method and apparatus for network slice management in the wireless communication system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1-15. (canceled)

16. A method performed by a network entity in a wireless communication system, the method comprising:
receiving a service profile including an attribute associated with a network slice validity,
wherein the attribute associated with the network slice validity is of a datatype comprising an expiryTime attribute, and
wherein the expiryTime attribute indicates information on a time at which a network slice is scheduled to be expired as the network slice is not required anymore.

17. The method of claim 16, wherein the attribute associated with the network slice validity:
has no default value set; and
is not nullable.

18. The method of claim 16, wherein the expiryTime attribute is mandatory, is readable, is not invariant, and is notifyable.

19. The method of claim 16, wherein the expiryTime attribute:
is of type DateTime;
has a multiplicity of 1;
has no default value set; and
is not nullable.

20. The method of claim 16, further comprising:
receiving an AllocateNSI (Network Slice Instance) request with the service profile including the attribute associated with the network slice validity; and
transmitting an AllocateNSI response.

21. The method of claim 16, further comprising:
receiving an createMOI (Managed Object Instance) request with the service profile including the attribute associated with the network slice validity; and
transmitting an createMOI response.

22. The method of claim 16,
receiving a modifyMOIAttributes request with the service profile including at least one attribute associated with a network slice validity; and
modifying a configuration related to the network slice, based on the received modifyMOIAttributes request.

23. The method of claim 16, wherein:
the service profile further includes an attribute associated with information on a scheduled period for a network slice availability, and
the attribute associated with information on the scheduled period for the network slice availability comprises a startTime attribute and an endTime attribute.

24. A network entity in a wireless communication system, comprising:
at least one transceiver;
at least one processor communicatively coupled to the at least one transceiver; and
at least one memory, communicatively coupled to the at least one processor, storing instructions executable by the at least one processor individually or in any combination to cause the network entity to:
receive a service profile including an attribute associated with a network slice validity,
wherein the attribute associated with the network slice validity is of a datatype comprising an expiryTime attribute, and
wherein the expiryTime attribute indicates information on a time at which a network slice is scheduled to be expired as the network slice is not required anymore.

25. The network entity of claim 24, wherein the attribute associated with the network slice validity:
has no default value set; and
is not nullable.

26. The network entity of claim 24, wherein the expiryTime attribute is mandatory, is readable, is not invariant, and is notifyable.

27. The network entity of claim 24, wherein the expiryTime attribute:
is of type DateTime;
has a multiplicity of 1;
has no default value set; and
is not nullable.

28. The network entity of claim 24, the instructions executable by the at least one processor individually or in any combination to cause the network entity further to:
receive an AllocateNSI (Network Slice Instance) request with the service profile including the attribute associated with the network slice validity; and
transmit an AllocateNSI response.

29. The network entity of claim 24, the instructions executable by the at least one processor individually or in any combination to cause the network entity further to:
receive an createMOI (Managed Object Instance) request with the service profile including the attribute associated with the network slice validity; and
transmit an createMOI response.

30. The network entity of claim 24, the instructions executable by the at least one processor individually or in any combination to cause the network entity further to:
receive a modifyMOIAttributes request with the service profile including at least one attribute associated with a network slice validity; and
modify a configuration related to the network slice, based on the received modifyMOIAttributes request.

31. The network entity of claim 24, wherein:
the service profile further includes an attribute associated with information on a scheduled period for a network slice availability, and
the attribute associated with information on the scheduled period for the network slice availability comprises a startTime attribute and an endTime attribute.
